(19) United States
(12) Patent Application Publication
(10) Pub. No.: US 2021/0220960 A1
(43) Pub. Date: Jul. 22, 2021

(54) FACETING METHOD AND DEVICE FOR SUCH A METHOD

(71) Applicant: MACK RIDES GMBH & CO. KG, Waldkirch (DE)

(72) Inventors: Hubert SCHILL, Elzach (DE); Günter BURGER, Waldkirch (DE)

(21) Appl. No.: 17/059,639

(22) PCT Filed: May 9, 2019
(86) PCT No.: PCT/EP2019/061985

§ 371 Date: Nov. 30, 2020

(30) Foreign Application Priority Data
Jun. 1, 2018 (DE) 10 2018 113 122.4

(51) Int. Cl. B24B 27/00; B24B 49/12; B24B 9/04; B25J 11/00; B25J 19/02

(52) U.S. Cl. CPC B24B 27/0038; B24B 49/12; B25J 19/022; B25J 11/0055; B24B 9/04

(57) ABSTRACT

The present invention relates to a method for faceting at least one workpiece edge (6) on at least one workpiece side (3, 4, 5) of at least one workpiece (2) by means of a device (1), comprising at least one workpiece holder (10), at least one measuring apparatus (30) and at least one faceting tool (40), which is movable relative to the workpiece holder (10), having the following method steps: —providing the at least one workpiece (2), —positioning and securing the at least one workpiece (2) on the workpiece holder (10), —determining the position of the at least one workpiece edge (6) of the at least one workpiece (2) relative to the workpiece holder (10), and—moving along the at least one workpiece edge (6) with the at least one faceting tool (40) and processing the facet.

The present invention relates to a method for faceting at least one workpiece edge on at least one workpiece side of at least one workpiece having the features of claim 1 and a device for faceting at least one workpiece edge of at least one workpiece having the features of claim 10.

Different designs of facets are known from prior art and are typically processed or integrally molded as a chamfer or edge fillet on workpiece edges of a planar workpiece, for example a metal sheet, in order to avoid sharp edges or burrs. Particularly in the case of sheet metal components that are to be coated after laser cutting, punching or nibbling, there is a need to provide the workpiece edge with a facet in order to prevent the coating from becoming inhomogeneous in the region of the workpiece edge. An inhomogeneous coating in the region of the workpiece edge often leads to the coating flaking off and thus to the destruction of the corrosion protection applied by the coating. In prior art, laser-cut, punched or nibbled planar workpieces are often deburred by hand using an appropriate disk brush or the like. It has proven to be disadvantageous that manual deburring leads to an inhomogeneous facet on the workpiece and requires a high level of personnel effort. A CNC-controlled facet is economically unfavorable due to the programming effort, particularly when manufacturing workpieces in small batches or as individual parts.

It is therefore the object of the present invention to propose a method as well as a device for faceting at least one workpiece edge of at least one workpiece that produces a homogeneous facet on the at least one edge of the at least one workpiece without any need for complex CNC programming. In addition, the method and the device are intended to work reliably, cost-effectively, with short downtimes and should be able to be carried out or used with little personnel effort. Furthermore, the method according to the invention and the device according to the invention are intended to enable simple and safe operation, so that the operating personnel can carry out the method or learn how to operate the device within a very short time and without having special prior knowledge. Furthermore, the device is intended to be simple and uncomplicated and to be usable with existing components in order to provide a system which is as cost-effective as possible and which can be used in a variety of ways.

According to the invention, these problems are solved by a method having the features of claim 1 and a device having the features of claim 10.

Advantageous further developments of the method and the device are specified in the dependent claims.

The method according to the invention for faceting at least one workpiece edge on at least one workpiece side of at least one workpiece by means of a device comprising at least one workpiece holder, at least one measuring apparatus and at least one powered faceting tool which is movable relative to the workpiece holder, comprises at least four method steps. In a first method step, the at least one workpiece is provided, which is typically a planar sheet metal part, wherein the method can be used regardless of the materials used. The workpiece preferably has a planar geometry, but it is also conceivable that the workpiece has a curved geometry or any other shape. In a further method step, the at least one workpiece is positioned and secured on the workpiece holder. Then, in a third method step, the position of the at least one workpiece edge relative to the workpiece holder on at least the first workpiece side of the workpiece is determined by the measuring apparatus, wherein the measuring apparatus detects the at least one workpiece edge on the at least one first workpiece side in the machine coordinate system of the device or in the coordinate system of the workpiece holder. After determining the position of the at least one workpiece edge on the at least one first workpiece side relative to the workpiece holder, the at least one workpiece edge is traversed by the faceting tool, wherein the faceting tool is brought into chip-removing contact while the at least one workpiece edge is being traversed. The facet is processed, for example, as an edge fillet, chamfer or another edge geometry.

It is advantageous if the workpiece is a metal sheet, in particular a planar metal sheet, which is provided by a punching process, laser cutting, a nibbling process or the like. Nibbling processes or handheld nibbling machines in particular, but also laser cutting processes and punching processes, are ideally suited both for separating workpieces from the starting material in the production of individual parts and for the production of workpieces in a small batch and lead to low scrap and chip waste during the production process.

Another advantageous embodiment of the method according to the invention provides that the workpiece is secured on the workpiece holder magnetically, by negative pressure and/or by force tension. In particular, magnetic securing but also securing by negative pressure to the workpiece holder lead to minor stresses in the workpiece and allow the workpiece to be secured regardless of its shape, meaning that no modifications need to be made to the workpiece holder in order to secure different workpieces.

It is also advantageous if the position of the at least one workpiece edge on the at least one workpiece side on the workpiece holder is determined by an optical measurement method. It is particularly preferred if the optical measurement method is carried out by means of a laser, which can be designed as a line laser, by means of which both the position of the at least one workpiece edge and the height of the at least one workpiece edge can be detected. Alternatively, the position of the at least one workpiece edge can be detected by a camera, in particular by means of a stereoscopic camera.

Another advantageous aspect of the method according to the invention provides that the position of the at least one workpiece edge on the workpiece holder is carried out by a machine-guided or handheld probe. The handheld probe in particular allows the teaching process on the device to be performed quickly, wherein the device learns the position of the at least one workpiece edge through the interaction of contact between the workpiece and the probe and the position of the probe. The position of the at least one workpiece edge on the at least one workpiece side is stored by the device or the machine control system. The powered faceting tool can then move along the workpiece edge and process the facet.

It is also advantageous if the at least one workpiece edge is traversed by the at least one powered faceting tool by means of a machine-controlled arm or a machine-controlled gantry. By means of the measuring apparatus, which is designed as a probe, the device learns the position of the at least one workpiece edge of the workpiece, and can move along the position of the at least one workpiece edge through three dimensions, as a result of which workpieces with any three-dimensional geometry can be faceted. It is particularly advantageous if the faceting tool is guided on a robotic arm that can move through three dimensions. Robotic arms of this kind can accommodate a large number of different tools or measuring apparatuses, they can be changed quickly and, moreover, are highly dynamic, as a result of which short downtimes can be achieved.

Another aspect of the method according to the invention provides that, after the at least one tool edge on the at least one first workpiece side of the at least one workpiece has been traversed by the faceting tool, the at least one workpiece is turned manually or mechanically so that a second workpiece side can be faceted.

In particular, however, it is preferred if the workpiece is turned mechanically by at least one gripper. The gripper can reposition the workpiece with the first workpiece side in the workpiece holder. The machine control system of the device can furthermore preferably calculate the position of the at least one workpiece edge on the second workpiece side based on the movement of the gripper, which means that it is not necessary to redetermine the at least one workpiece edge on the second workpiece side. In particular, it is preferred that a plurality of grippers are provided for turning the at least one workpiece. Auxiliary equipment can also be provided, which enables the at least one workpiece to be gripped differently by placing the at least one workpiece down once or multiple times.

It is also advantageous if the faceting tool produces an edge fillet or a chamfer on the at least one workpiece edge. It is particularly preferred if the faceting tool is a milling or grinding tool.

A further aspect of the present invention relates to a device for faceting at least one workpiece edge of at least one workpiece using a method described above, wherein the device for faceting has at least one workpiece holder for positioning and securing the at least one workpiece, by means of which the workpiece is held while the method is carried out. In addition, the device comprises at least one measuring apparatus, which is set up to determine the position of the at least one workpiece edge of the at least one workpiece on the workpiece holder region. The position of the at least one workpiece edge in the machine coordinate system of the device can be detected and stored by the at least one measuring apparatus.

The term workpiece edge is understood to mean workpiece edges that do not necessarily have to extend in a straight line, but can have any contour. Such workpiece edges can therefore also extend in an oval, round, or otherwise curved manner. The workpiece can therefore have any outer contour. It is essential to detect the outer contour with the measuring apparatus, for example by moving along it. This can be done, for example, by means of measuring points that are spaced apart from one another. The measuring points can, for example, be arranged at spacings of 1 mm. The result of moving along the outer contour of the workpiece in this way is a contour line of the outer periphery of the workpiece with a number of measurement support points, which can be combined by means of interpolation to form a continuous line. Straight intermediate lines or curved lines can be calculated (vectorized) between individual measurement points in order to detect a “smoothed” outer contour of the workpiece. Once the entire outer contour of the workpiece has been detected with the measuring apparatus, this outer contour, i.e. the outer workpiece edge, can be deburred during the subsequent machining step.

In addition, the device comprises at least one powered faceting tool, which can move along at least one workpiece edge to produce the facet. For this purpose, the faceting tool is advanced mechanically to the at least one workpiece edge by a machine control system of the device on the basis of the two- or three-dimensional stored data.

In addition, it is particularly advantageous if the at least one workpiece holder comprises a magnetic clamp, a negative pressure clamp and/or a force clamp. Particularly preferably, the clamping apparatus is an electric and/or permanent magnetic clamp and/or a negative pressure clamp, which is characterized by a low mechanical load on the workpiece and can be used irrespective of the geometry of the workpiece to be machined. Since ferromagnetic metal sheets are particularly preferably processed in the proposed method, the magnetic clamp for magnetically clamping the workpiece is particularly preferred. Magnetic auxiliary equipment for magnetic clamping can be used for non-magnetic workpieces.

It is also advantageous if the at least one measuring apparatus comprises a machine-guided or handheld probe which detects the position of the at least one workpiece edge of the at least one workpiece. The probe can furthermore preferably detect the position of the workpiece edge two- or three-dimensionally on the basis of probing pressure, by means of which contact between the probe and the workpiece is detected, as a result of which the position of the at least one workpiece edge of the workpiece or the complete shape of the workpiece can be described for the control system of the device. In particular, the hand-guided probing of the at least one workpiece edge enables user-controlled teaching in of the device.

Another advantageous embodiment of the present invention provides that a machine-operated arm or a machine-operated gantry is provided, which has the faceting tool. The machine-operated arm or the machine-operated gantry can, after detecting the position of the at least one workpiece edge, move along the at least one workpiece edge in a fully automated manner, wherein it is particularly preferred for intelligent control software to move along an optimized advancement path on the basis of the two- or three-dimensionally stored data of the position of the at least one workpiece edge, in order to keep downtimes as short as possible.

It is advantageous if the machine-operated arm or the machine-operated gantry has a swivel head, wherein the swivel head can hold the measuring apparatus and/or the faceting tool and/or at least one gripper. Between determining the position of the at least one workpiece edge of the at least one workpiece and moving along the workpiece edge with the faceting tool, the machine-operated arm or the machine-operated gantry can exchange the measuring apparatus for the faceting tool or the gripper, which reduces the risk of contamination of the measuring apparatus or the gripper. The at least one faceting tool, the at least one measuring apparatus and the at least one gripper can be stored in a corresponding magazine of the device.

It is also advantageous if the machine-operated arm or the machine-operated gantry has a swivel head, wherein the swivel head comprises the at least one measuring apparatus, the at least one faceting tool and/or the at least one gripper. After determining the position of the at least one workpiece edge on the at least one workpiece side of the at least one workpiece, the faceting tool can be guided, by swiveling the swivel head, into chip-removing engagement to produce the facet on the workpiece edge. Furthermore, by further swiveling the at least one gripper, the workpiece can be lifted by the workpiece holder and, by turning to facet the workpiece on the back, the workpiece can be positioned again on the workpiece holder. The machine control system can determine the position of the at least one workpiece edge by converting the position of the at least one workpiece edge without any further determination by the measuring apparatus, and the facet can be processed immediately.

It is also advantageous if the at least one faceting tool is a milling tool. The milling tool can furthermore preferably process a predefined facet in the form of an edge fillet, chamfer or an ornamental geometry with any shape on the at least one workpiece edge, which satisfies the requirements for a coating to be carried out after faceting.

The method according to the invention and the device according to the invention are explained below with reference to a FIGURE. In the drawings:

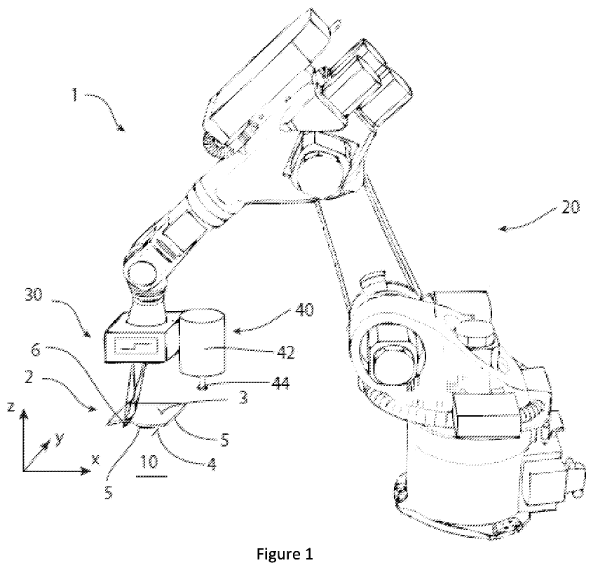

FIG. 1: a machine-operated arm with a swivel head, wherein the swivel head comprises a measuring apparatus for detecting the at least one workpiece edge of a workpiece on at least one workpiece side and a faceting tool designed as a milling cutter.

FIG. 1 shows an embodiment example of the device 1 according to the invention for carrying out a method according to the invention for faceting at least one workpiece edge 6 of at least one workpiece 2. The device 1 comprises a workpiece holder 10, a machine-operated arm 20, a swivel head 25, a measuring apparatus 30, a faceting tool 40 and a machine control system (not shown).

The workpiece 2 can have any shape and, in the illustrated embodiment example, is a planar metal sheet with a first workpiece side 3 and a second workpiece side 4 and four end-face workpiece sides 5, the first workpiece side 3 and the second workpiece side 4 being the two opposite main surfaces. The workpiece 2 shown comprises a plurality of workpiece edges 6, which are each arranged at the transition between the workpiece sides 3, 4, 5. Although a rectangular workpiece in the form of a planar metal sheet is shown in the illustrated embodiment example, the workpiece 2 is of course not limited to such an outer contour. Rather, the workpiece 2 can have any outer contour, e.g. a round or oval structure, so that the workpiece edge is then designed as a circular or oval-shaped, circumferential ring. Any other external contours of the workpiece 2 are also possible.

The workpiece holder 10 is designed as a supporting table 15 (not shown) and is set up to hold and secure at least one workpiece 2. To secure the workpiece 2 on the workpiece holder 10, the device 1 further comprises a negative pressure clamp, a magnetic clamp or a force clamp. The negative pressure apparatus can apply a negative pressure, which acts on the workpiece 2, via a plurality of openings in the side facing the workpiece 2. The workpiece 2 is secured on the workpiece holder 10 in any position, this being preferably actuated by the machine control system.

The magnetic clamp can be electromagnetic and/or permanent magnetic and can be controlled and regulated by the machine control system. The magnetic clamp is particularly suitable for faceting ferromagnetic workpieces 2, with it also being possible for such a magnetic clamp to fasten non-magnetic workpieces 2 to the workpiece holder 10 by means of suitable magnetic aids.

The machine-operated arm 20, which is designed as a robotic arm with a plurality of axes of rotation, as illustrated in FIG. 1, can have a swivel head 25, which can be moved and pivoted as desired by the machine-operated arm 20 relative to the workpiece holder. The machine-operated arm 20 can be controlled and regulated by the machine control system.

The swivel head 25 comprises at least one tool holder, which can hold the measuring apparatus 30 and the faceting tool 40 and which can bring the measuring apparatus 30 or the faceting tool 40 into an engagement position by means of a corresponding swivel movement. The swivel head 25 enables the measuring apparatus 30 or the faceting tool 40 to be brought into an engagement position with respect to the workpiece 2 in order to detect the workpiece 2 by measurement or to machine the workpiece 2 with the faceting tool 40.

In addition, the swivel head 25 can comprise a gripper 50 (not illustrated), which is set up to lift and turn the workpiece 2.

The measuring apparatus 30 preferably comprises a line laser designed as an edge detector. To detect the position of the at least one workpiece edge 6 on the first workpiece side 3, the measuring apparatus 30 is guided by the machine-operated arm 20 in parallel with the workpiece holder 10.

The measuring apparatus 30 can selectively determine the position of the workpiece edge 6 as two-dimensional coordinates (y₁, z₁) or three-dimensional coordinates (x₁, y₁, z₁) in the machine coordinate system using the optical laser measurement method and, on the basis of a plurality of two- or three-dimensional coordinates (x₁, y₁, z₁), and map the position of the workpiece edge 6 in the machine coordinate system for later machining with the faceting tool 40. The calculation of the position of the at least one workpiece edge 6 of the workpiece 2 can be carried out by the machine control system. For example, a vector-based model in the form of CAD data or the like can be exported to an external data carrier via a suitable interface. A continuous course of the entire workpiece edge 6 is determined in a vectorized manner from the plurality of recorded measuring points (“point cloud”).

The faceting tool 40 comprises a milling spindle 42 and a milling tool 44, which can be designed, for example, as a beveled cutter, a radius cutter, a double radius cutter, etc. The milling spindle 42 drives the milling tool 44, with the milling spindle 42 being controlled or regulated by the machine control system. The shape of the faceting tool 40 corresponds to the facet to be produced.

The swivel head 25 can exchange the measuring apparatus 30 for the faceting tool 40 and bring it into the engagement position.

The device 1 can comprise a magazine (not illustrated) which is set up to hold the measuring apparatus 30, different faceting tools 40 or different grippers 50 in order to provide the particular tool required for the swivel head 25.

According to the invention it is envisaged, when carrying out the method, that the workpiece 2 is first provided for faceting by laser cutting, punching, nibbling, cutting, sawing or the like and is positioned on the workpiece holder 10 with any orientation. The workpiece 2 is then secured on the workpiece holder 10 by the negative pressure, magnetic and/or force clamp 17.

The machine-operated arm 20 then moves with the measuring apparatus 30 along the workpiece holder 10 in a predetermined pattern and detects the position of the at least one workpiece edge 6 by measurement. For this purpose, the position (x, y, z) is detected three-dimensionally in the machine coordinate system at at least two points, wherein the position of the workpiece edge 6 corresponds to the vector (X, Y, Z) between at least two adjacent positions (xᵢ, yᵢ, zᵢ) and (xᵢ₊₁, yᵢ₊₁, zᵢ₊₁).

As soon as the position of the at least one workpiece edge 6 of the at least one workpiece 2 is determined, the tool or the measuring apparatus 30 on the powered arm 20 can be exchanged for the faceting tool 40 and brought into the engagement position.

The machine control system calculates a travel path for the machine-driven arm 20 with the at least one faceting tool 40 and moves along the at least one workpiece edge 6 of the at least one workpiece 2 with the faceting tool 40 and works the facet into the workpiece 2 with the milling tool 44.

After the at least one workpiece edge 6 has been traversed by the faceting tool 40, the swivel head 25 can exchange the faceting tool 40 for the gripper 50 and turn the at least one workpiece 2. First, the securing action of the clamping apparatus 16 is released and the gripper 50 can grip the workpiece 2, for example by means of negative pressure, electromagnetically and/or permanent magnetically or mechanically.

A second gripper (not illustrated) or a suitable auxiliary apparatus (not illustrated) can furthermore be provided to grip the workpiece 2 with the gripper 50 in a different way. To machine the second workpiece side 4, the gripper 50 positions the workpiece 2 with its first workpiece side 3 on the workpiece holder 10. The workpiece 2 is then secured again on the workpiece holder 10 by the clamping apparatus 16.

The machine control system can furthermore determine the at least one workpiece edge 6 on the second workpiece side 4 by transforming the position of the at least one workpiece edge 6 on the first workpiece side 3, such that the at least one workpiece edge 6 on the second workpiece side 4 can be traversed by the faceting tool 40—without re-determining the position of the at least one workpiece edge 6 on the second workpiece side 4 by means of the measuring apparatus 30.

### LIST OF REFERENCE NUMERALS

1 device
2 workpiece
3 first workpiece side
4 second workpiece side
5 end face
6 workpiece edge
10 workpiece holder
15 supporting table
17 clamping apparatus
20 machine-operated arm
30 measuring apparatus
40 faceting tool
42 milling spindle
44 milling tool
50 gripper

1. A method for faceting at least one workpiece edge (6) on at least one workpiece side (3, 4, 5) of at least one workpiece (2) by means of a device (1) comprising at least one workpiece holder (10), at least one measuring apparatus (30) and at least one powered faceting tool (40) which is movable relative to the workpiece holder (10), having the following method steps:
providing the at least one workpiece (2),
positioning and securing the at least one workpiece (2) on the workpiece holder (10),
determining the position of the at least one workpiece edge (6) relative to the workpiece holder (10), and
moving along the at least one workpiece edge (6) with the at least one faceting tool (40) and processing the facet.

2. The method according to claim 1, characterized in that the workpiece (2) is a metal sheet, in particular a planar metal sheet, which is provided by a punching process, laser cutting or a nibbling process.

3. The method according to claim 1, characterized in that the workpiece (2) is secured on the workpiece holder (10) magnetically, by negative pressure and/or by force tension.

4. The method according to claim 1, characterized in that the position of the at least one workpiece edge (6) on the at least one workpiece side (3, 4, 5) on the workpiece holder (10) is determined by an optical measurement method using the at least one measuring apparatus (30).

5. The method according to claim 1, characterized in that the positioning of the at least one workpiece edge (6) on the at least one workpiece side (3, 4, 5) is carried out by a machine-guided or handheld probe.

6. The method according to claim 1, characterized in that the at least one workpiece edge (6) is traversed by the at least one faceting tool (40) using a machine-controlled arm (20) or a machine-controlled gantry.

7. The method according to claim 1, characterized in that the faceting tool (40) produces an edge fillet or a chamfer on the workpiece edge (6).

8. The method according to claim 1, characterized in that the workpiece (2) on the workpiece holder (10) is turned mechanically by at least one gripper (50) or manually.

9. The method according to claim 8, characterized in that the position of the at least one workpiece edge (6) on a second workpiece side (4) is calculated after turning.

10. A device (1) for faceting at least one workpiece edge (6) of at least one workpiece (2) in accordance with a method according to claim 1, comprising:
at least one workpiece holder (10) for positioning and securing the at least one workpiece (2),
at least one measuring apparatus (30) for determining the position of the at least one workpiece edge (6) of the at least one workpiece (2),
at least one powered faceting tool (40) which can move along the at least one workpiece edge (6) to produce the facet.

11. The device (1) according to claim 8, characterized in that the at least one holder (10) comprises a magnetic clamp, a negative pressure clamp and/or a force clamp.

12. The device (1) according to claim 10, characterized in that the measuring apparatus (30) detects the at least one workpiece edge (6) of the at least one workpiece (2) with an optical measurement method, in particular by means of a laser.

13. The device (1) according to claim 10, characterized in that the at least one measuring apparatus (30) comprises a machine-guided or handheld probe which can detect the at least one workpiece edge (6) of the at least one workpiece (2).

14. The device (1) according to claim 10, characterized in that a machine-operated arm (20) or machine-operated gantry is provided, which has the faceting tool (40) and guides the faceting tool (40) along the at least one workpiece edge (6) of the workpiece (2).

15. The device (1) according to claim 14, characterized in that the machine-operated arm (20) or the machine-operated gantry has a swivel head, wherein the swivel head can hold the at least one measuring apparatus (30), the at least one faceting tool (40) and/or at least one gripper (50).

16. The device (1) according to claim 14, characterized in that the machine-operated arm (20) or the machine-operated gantry has a swivel head (25), wherein the swivel head (25) comprises the at least one measuring apparatus (30) and/or the at least one faceting tool (40) and/or at least one gripper (50).

17. The device (1) according to claim 10, characterized in that the at least one faceting tool (40) comprises a milling spindle (42) and a milling tool (44).
